(19) United States
(12) Patent Application Publication
(10) Pub. No.: US 2016/0335824 A1
(43) Pub. Date: Nov. 17, 2016

(54) EJECTING UNIT AND COIN-ROLL PROCESSING DEVICE

(71) Applicant: GLORY LTD., Himeji-shi (JP)

(72) Inventor: Hirofumi TOGO, Himeji-shi (JP)

(73) Assignee: GLORY LTD., Himeji-shi (JP)

(21) Appl. No.: 15/153,161

(22) Filed: May 12, 2016

(30) Foreign Application Priority Data
May 15, 2015 (CN) 201520315838.X

(51) Int. Cl. G07D 1/00; G07D 9/00

(52) U.S. Cl. CPC G07D 1/00; G07D 9/004

(57) ABSTRACT

An ejecting unit (70) that ejects roll of coins from inside to outside of a housing (2) of a coin-roll processing device (1) includes an accommodating section (72) that accommodates a roll of coins to be ejected from inside to outside of the housing (2), and a shutter (74) rotatable between a closed position and an open position, the closed position is a position in which the shutter (74) blocks a coin-roll removal opening (71a) provided in a front part of the accommodating section (72), and the open position is a position in which the coin-roll removal opening (71a) is open. When the shutter (74) is located in the open position, a placement surface (72a) on which the roll of coins is placed in the accommodating section (72) and an inner surface (74b) of the shutter (74) continue smoothly.

### CROSS REFERENCE TO THE RELATED APPLICATION

This application is based upon and claims the benefit of priority from the prior Chinese Patent Application No. 201520315838.X filed on May 15, 2015, the entire contents of which are incorporated herein by reference.

### FIELD OF THE INVENTION

1. Field of the Invention

The present invention relates to an ejecting unit for ejecting a roll of coins from inside to outside of a housing of a coin-roll processing device, and to a coin-roll processing device including such an ejecting unit.

2. Description of the Related Art

Various types of coin-roll ejecting devices, each including a plurality of storing units capable of storing therein a plurality of roll of coins and having an ejecting mechanism for ejecting the roll of coins stored in the storing units, are known in the art. For example, Japanese Patent Application Laid-Open No. 2013-61822 (JP2013-61822A) discloses such a coin-roll processing device. This coin-roll processing device forms a roll of coins by wrapping a predetermined number of loose coins, stores the formed roll of coins in the storing unit, and dispenses the roll of coins stored in the storing unit to the outside when required. In such a coin-roll processing device, when performing a dispensing process of dispensing roll of coins, the roll of coins stored in the storing unit are fed out one by one to a transporting unit, and the fed-out roll of coins is transported by the transporting unit to a dispensing unit, thereby accumulating in the dispensing unit the necessary number of the roll of coins that need to be dispensed. The dispensing unit includes a shutter. When all the necessary number of the roll of coins that need to be dispensed are accumulated in the dispensing unit, an operator can open the shutter, grasp the roll of coins accumulated in the dispensing unit with the hand, and take out the roll of coins from the housing. Instead of manually opening the shutter, the shutter can be opened automatically.

### SUMMARY OF THE INVENTION

In some coin-roll processing devices, the shutter of the dispensing unit opens away from the housing. However, in this type of the coin-roll processing device, when the shutter is opened away from the housing, a placement surface on which the roll of coins is placed in the dispensing unit and an inner surface of the shutter that is opened away from the housing do not continue smoothly. Therefore, in the opened state of the shutter, it is difficult to grasp the roll of coins that is accumulated in the dispensing unit with the hand and take them out by pulling toward the operator. In the typical coin-roll processing devices, an impact absorber, such as an impact absorption sponge, is used in the dispensing unit at a place where the roll of coins is accumulated. Moreover, a rubber sheet is pasted on the top surface of the impact absorber to prevent damage of the impact absorber by the claws and the like of the operator when the operator takes out the roll of coins from the dispensing unit. However, because the rubber sheet has a high friction coefficient, when grasping the roll of coins accumulated in the dispensing unit with the hand and taking them out by pulling toward the operator, a finger or a fingernail of the operator, or the grasped roll of coins itself may be caught in the rubber sheet. When this happens, it is difficult to take out a bunch of the roll of coins accumulated in the dispensing unit.

The present invention was made in view of the above discussion. One object of the present invention is to provide an ejecting unit in which it is easy to take out a bunch of the roll of coins accumulated in an accommodating section while grasping with the hand, and to provide a coin-roll processing device including such an ejecting unit.

The present invention is an ejecting unit for ejecting a roll of coins from inside to outside of a housing of a coin-roll processing device, including: an accommodating section that accommodates a roll of coins to be ejected from inside to outside of the housing; and a shutter rotatable between a closed position and an open position around a shaft, the closed position being a position in which the shutter blocks a coin-roll removal opening provided in a front part of the accommodating section and the open position being a position in which the coin-roll removal opening is open, and when the shutter is located in the open position, a placement surface on which the roll of coins is placed in the accommodating section and an inner surface of the shutter continue smoothly.

In the ejecting unit of the present invention, the shutter may extend upward from the shaft when the shutter is located in the closed position, and the shutter may be reclined away from a body of the ejecting unit when the shutter is rotated from the closed position to the open position.

In the ejecting unit of the present invention, a front end of the accommodating section may be located near the shaft of the shutter.

In the ejecting unit of the present invention, when the shutter is located in the open position, the inner surface of the shutter and the placement surface of the accommodating section located near the shutter may be substantially in one plane.

In this case, when the shutter is located in the open position, both the inner surface of the shutter and the placement surface of the accommodating section located near the shutter may be inclined to a horizontal plane.

In the ejecting unit of the present invention, a gap between the inner surface of the shutter when the shutter is located in the open position and the placement surface of the accommodating section may be narrower than a diameter of the roll of coins.

In the ejecting unit of the present invention, the accommodating section may be include a base material and a low friction member that is provided on a top surface of the base material and has a lower friction coefficient than the base material, and the roll of coins accommodated in the accommodating section is placed on the low friction member.

In this case, the base material may include an impact absorber.

Further, the low friction member may include a film.

The present invention is a coin-roll processing device including: a storing unit that stores a roll of coins and capable of feeding out the stored roll of coins; a transporting unit that transports the roll of coins fed out from the storing unit; and the ejecting unit as described above, and the roll of coins transported by the transporting unit to the ejecting unit is accommodated in the accommodating section of the ejecting unit.

The present invention is an ejecting unit for ejecting a roll of coins from inside to outside of a housing of a coin-roll processing device, including: an accommodating section that accommodates a roll of coins to be ejected from inside to outside of the housing; and a shutter rotatable between a closed position and an open position around a shaft, the closed position being a position in which the shutter blocks a coin-roll removal opening provided in a front part of the accommodating section and the open position being a position in which the coin-roll removal opening is open, and the accommodating section includes a base material and a low friction member that is provided on a top surface of the base material and has a lower friction coefficient than the base material, and the roll of coins accommodated in the accommodating section is placed on the low friction member.

In the ejecting unit of the present invention, the base material may include an impact absorber.

In the ejecting unit of the present invention, the low friction member may include a film.

The present invention is a coin-roll processing device including: a storing unit that stores a roll of coins and capable of feeding out the stored roll of coins; a transporting unit that transports the roll of coins fed out from the storing unit; and the ejecting unit as described above, and the roll of coins transported by the transporting unit to the ejecting unit is accommodated in the accommodating section of the ejecting unit.

### BRIEF DESCRIPTION OF THE DRAWINGS

FIG. 1 is a perspective view of an appearance of a coin-roll processing device according to an embodiment of the present invention.

FIG. 2 is a perspective view of an internal configuration of the coin-roll processing device shown in FIG. 1.

FIG. 3 is a side view depicting an outline of an internal configuration of the coin-roll processing device shown in FIG. 1 and the like.

FIG. 4 is an enlarged side view depicting in an enlarged manner details of an upper part of the internal configuration of the coin-roll processing device shown in FIG. 3.

FIG. 5 is a perspective view of a configuration of an ejecting unit of the coin-roll processing device shown in FIG. 1 and the like.

FIG. 6 is a side view depicting an outline of the configuration of the ejecting unit shown in FIG. 5.

FIG. 7 is a side view depicting details of a configuration of an accommodating section of the ejecting unit shown in FIG. 6.

### DETAILED DESCRIPTION OF THE INVENTION

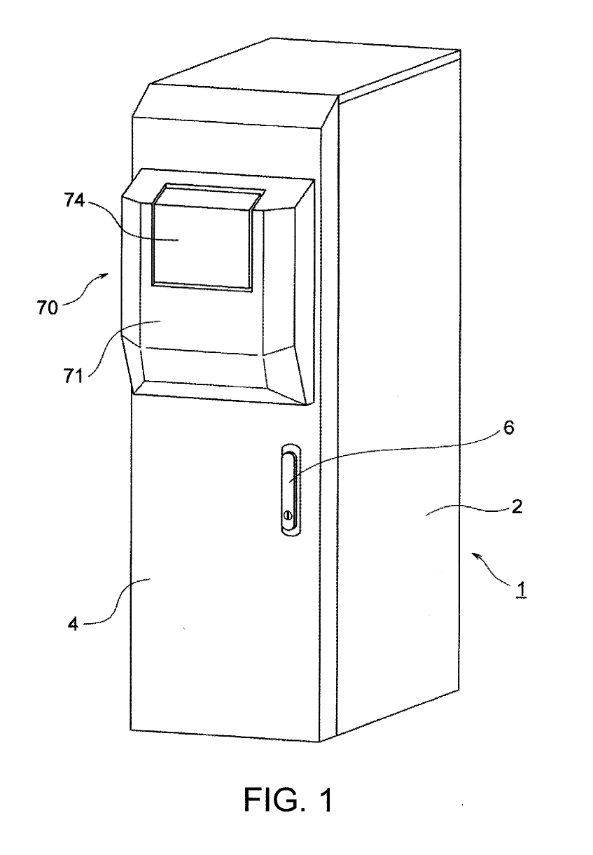

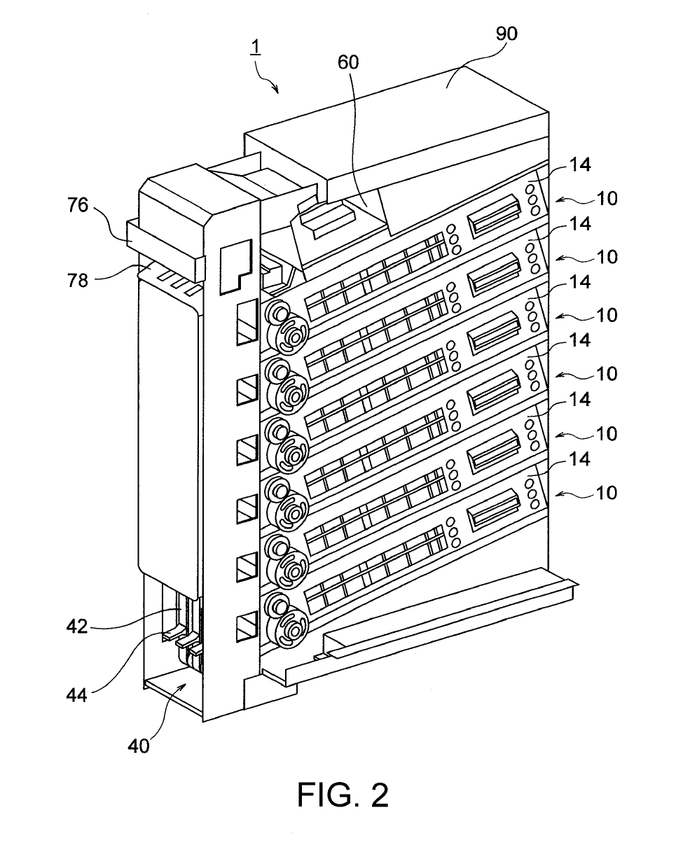

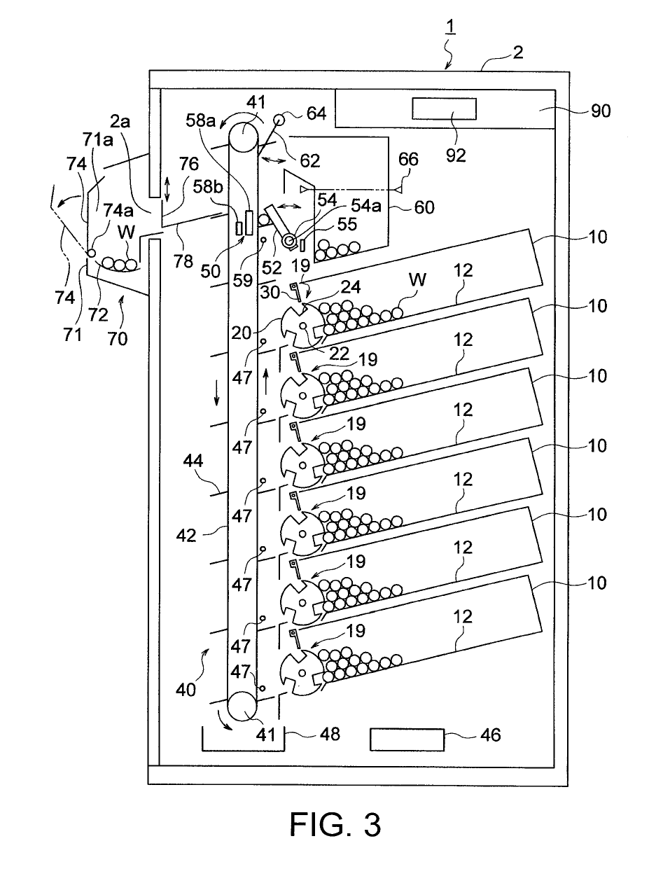

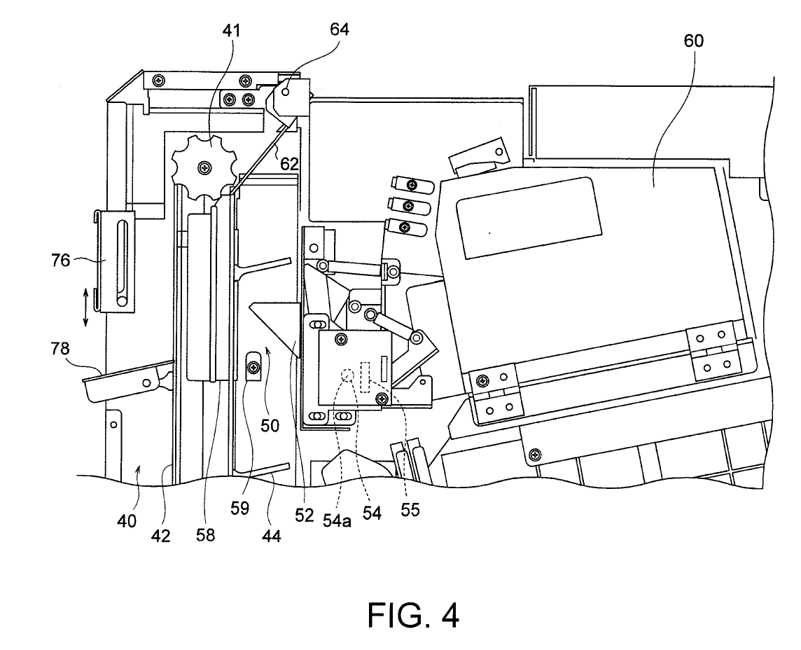

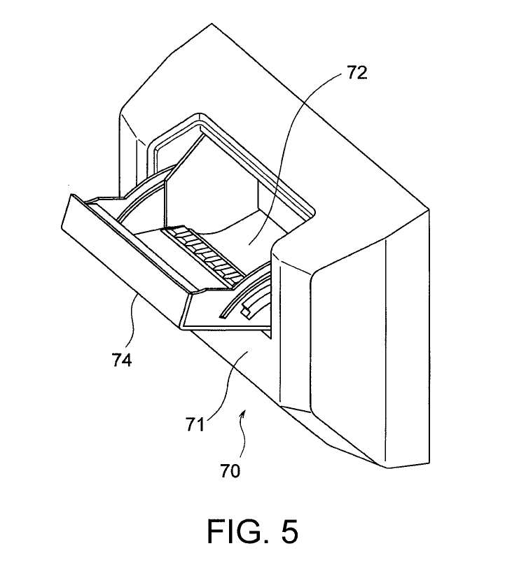

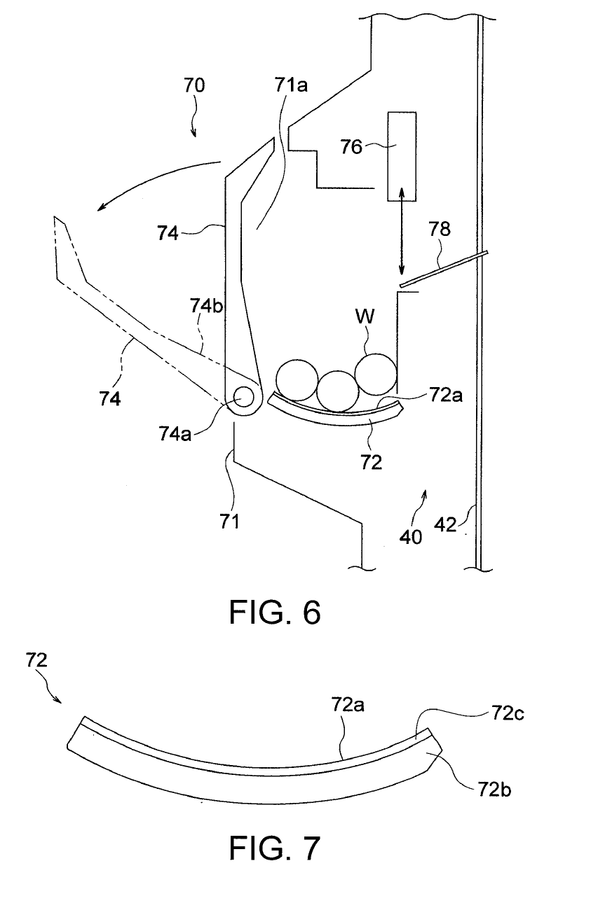

Exemplary embodiments of the present invention are explained below with reference to the accompanying drawings. FIGS. 1 to 7 depict a coin-roll processing device according to one embodiment of the present invention. FIG. 1 is a perspective view of an appearance of the coin-roll processing device according to the present embodiment. FIG. 2 is a perspective view of an internal configuration of the coin-roll processing device shown in FIG. 1. FIG. 3 is a side view depicting an outline of an internal configuration of the coin-roll processing device shown in FIG. 1 and the like. FIG. 4 is an enlarged side view depicting in an enlarged manner details of an upper part of the internal configuration of the coin-roll processing device shown in FIG. 3. FIG. 5 is a perspective view of a configuration of an ejecting unit of the coin-roll processing device shown in FIG. 1 and the like. FIG. 6 is a side view depicting an outline of the configuration of the ejecting unit shown in FIG. 5. FIG. 7 is a side view depicting details of a configuration of an accommodating section of the ejecting unit shown in FIG. 6.

The coin-roll processing device according to the present embodiment has a configuration to store a plurality of roll of coins per denomination inside a body thereof and to eject the stored roll of coins outside of the body. As shown in FIGS. 1 to 3, a coin-roll processing device 1 according to the present embodiment includes a housing 2 having a substantially rectangular parallelepiped shape and a plurality of storing units 10 (e.g., six) arranged in the housing 2 one above another along a vertical direction. Each of the storing units 10 includes a bottom surface 12 (see FIG. 3) that supports the stored roll of coins, and an ejecting mechanism 19 that ejects the roll of coins one by one from a side of the bottom surface 12 that is at a lower level with respect to the vertical direction. Moreover, the coin-roll processing device 1 according to the present embodiment includes a transporting unit 40 that transports the roll of coins one by one that is fed out from the storing unit 10 by the ejecting mechanism 19, an ejecting unit 70 that ejects the roll of coins transported by the transporting unit 40 from inside to outside of the housing 2, and a reject unit 60 that stores therein those roll of coins that should not be ejected from inside to outside of the housing 2 among a plurality of roll of coins transported by the transporting unit 40. A controlling unit 90 that controls various components of the coin-roll processing device 1 is installed in the housing 2 of the coin-roll processing device 1. A detailed explanation is given below about the various components of the coin-roll processing device 1.

As shown in FIG. 3, in each of the storing units 10, the roll of coins is stored on the bottom surface 12 in a piled-up manner. A plurality of roll of coins accumulates at the low-level side of the bottom surface 12 by rolling toward a direction (i.e., a lower left direction in FIG. 3) of inclination of the bottom surface 12 with respect to a horizontal plane. The term “to store a plurality of roll of coins in a piled-up manner” includes, depending on the number of the roll of coins stored in the storing unit 10, a situation where a plurality of roll of coins is piled-up in several layers on the bottom surface 12, a situation where a plurality of roll of coins is lined-up in one layer (one row) on the bottom surface 12, or a situation where there is only one roll of coins. Moreover, a plurality of roll of coins may be stored in an orderly and properly aligned manner, or a plurality of roll of coins may be stored in a non-orderly manner although their directions may be aligned. That is, what is meant here is that, although a plurality of roll of coins can be piled-up in several layers, it is not necessary that a plurality of roll of coins is piled-up in several layers, and it is not necessary that a plurality of roll of coins is properly aligned.

An angle of inclination of the bottom surface 12 of each of the storing units 10 with respect to the horizontal plane is within the range of 8 degrees to 20 degrees. Moreover, the maximum static friction coefficient of the bottom surface 12 of each of the storing units 10 with respect to the roll of coins is within the range of 0.01 to 0.15. As a result, the roll of coins that is in contact with the bottom surface 12 among a plurality of roll of coins stored in each of the storing units 10 slide or roll by their weight along the inclined bottom surface 12 toward the ejecting mechanism 19 without being stopped by a frictional force between them and the bottom surface 12.

Each of the storing units 10 includes a pair of side walls that constitutes a storing area for the roll of coins. At least one of the side walls constitutes a door 14 (see FIG. 2) that is opened/closed when replenishing the roll of coins in the storing unit 10 or taking out the roll of coins from the storing unit 10. The side wall of the storing unit 10 that constitutes the door 14 is made from a transparent member or a semi-transparent member, for example, so that the operator can see inside the storing unit 10 through this side wall. Instead of making the door 14 with a transparent member or a semi-transparent member, the door 14 can be provided with a slit, a hole, and the like, to allow the operator to see inside the storing unit 10.

As explained earlier, each of the storing units 10 includes the bottom surface 12 that support the stored roll of coins, and the ejecting mechanism 19 that ejects the roll of coins one by one from a side of the bottom surface 12 that is at a lower level with respect to the vertical direction. Detailed explanation about a configuration of the ejecting mechanism 19 is given below with reference to FIG. 3. Each of the ejecting mechanisms 19 includes a rotating member 20 that is arranged on a rotation axis 22 to be rotatable in the counterclockwise direction in FIG. 3 with the rotation axis 22 as the center. The rotation axis 22 extends horizontally but orthogonally to the direction of inclination of the storing unit 10 (i.e., extends orthogonally to the paper sheet of FIG. 3). Each of the rotating members 20 is provided with at least two notches 24 (three notches are shown in the example shown in FIG. 3 and the like). One notch receives one roll of coins stored in the storing unit 10. A gate member 30 is arranged above the rotating member 20 in the ejecting mechanism 19. This gate member 30 prevents a situation where the roll of coins stored in the storing unit 10 does not enter into the notches 24 of the rotating member 20 whereby it is ejected from above the rotating member 20. That is, as shown in FIG. 3, by blocking a gap between a top surface of the storing unit 10 and the rotating member 20 with the gate member 30, when a large number of the roll of coins have been stored in the storing unit 10, it is prevented that the roll of coins is ejected on the transporting unit 40 side from this gap between the top surface of the storing unit 10 and the rotating member 20.

In the present embodiment, the roll of coins of which denomination should be stored in which of the storing unit 10 is set previously. When making this setting, it is possible to set such that the roll of coins of the same denomination is stored in a plurality of the storing units 10.

As shown in FIG. 3, the transporting unit 40 is arranged inside the housing 2 nearer to the front side (i.e., on the left of the storing units 10 in FIG. 3) than the storing units 10. The roll of coins ejected by the ejecting mechanism 19 from each of the storing units 10 are transported one by one by the transporting unit 40. The transporting unit 40 includes two pulleys 41, an endless belt 42, and a driving motor 46. One pulley 41 is arranged in the upper part and the other pulley 41 is arranged in the lower part of the housing 2. The endless belt 42 is stretched over those two pulleys 41. The driving motor 46 rotationally drives one of the pulleys 41 (specifically, the pulley 41 arranged in the lower part in FIG. 3) to rotate the endless belt 42 to perform a cyclic shift in the counterclockwise direction in FIG. 3. As shown in FIG. 3, the endless belt is provided with a plurality of protruding members 44. The roll of coins fed out from the storing units 10 by the ejecting mechanism 19 is caught by those protruding members 44. The protruding members 44 project out from the endless belt 42 in an inclined manner. That is, the surface of the protruding member 44 that contacts the roll of coins makes a predetermined angle (e.g., within the range of 45 degrees to 80 degrees, and preferably, for example, 60 degrees) with respect to a direction in which the endless belt 42 extends (i.e., the vertical direction in FIG. 3). Because the protruding members 44 are inclined with respect to the direction in which the endless belt 42 extends, the roll of coins caught in the protruding members 44 is shifted toward the endless belt 42 on the protruding members 44 by their weight. When the endless belt 42 makes the cyclic shift in the counterclockwise direction in FIG. 3, by the movement of the endless belt 42, the roll of coins that is fed out from the storing units 10 by the ejecting mechanism 19 are transported along a direction shown with a straight arrow in FIG. 3 in a state of being caught in the protruding members 44 (i.e., shifted on the protruding member 44 toward the endless belt 42). In the present embodiment, the endless belt 42 is driven by the driving motor 46 to perform intermittent shifts. That is, the endless belt 42 is shifted by a predetermined distance and stopped for a predetermined time, and this operation is repeated.

Only one endless belt 42 is shown in FIG. 3; however, in reality, three endless belts 42 are arranged parallel to but separated from each other (see FIG. 2). The protruding members 44 of all the endless belts 42 are arranged at the same phase in a direction of shift of the endless belts 42. That is, the roll of coins fed out from the storing unit 10 by the ejecting mechanism 19 is caught in three corresponding protruding members 44 of all the three endless belts 42.

As shown in FIG. 3, the transporting unit 40 includes a sensor 47, including a photo-interrupter and the like, corresponding to each of the storing units 10. The sensors 47 detect the roll of coins fed out from the storing units 10 by the ejecting mechanism 19. When the roll of coins is fed out from the storing unit 10 by the ejecting mechanism 19, this roll of coins can be detected by the sensor 47. As shown in FIG. 3, the sensors 47 are arranged in a region in which the protruding members 44 of the endless belt 42 shift. Accordingly, the sensors 47 can also detect the protruding members 44 of the endless belt 42. With this arrangement, the sensors 47 can detect a situation where, when the endless belt 42 is making the cyclic shift in the counterclockwise direction in FIG. 3, the endless belt 42 cannot make the cyclic shift at a predetermined speed because of jamming of the roll of coins and the like.

As shown in FIG. 3, a coin receiving unit 48, including a tray and the like, is arranged below the transporting unit 40. When the endless belt 42 makes the cyclic shift in the counterclockwise direction in FIG. 3 while the protruding members 44 have caught the roll of coins, there may be a situation where the packaging paper of the roll of coins may be torn and some coins become loose and fall down by their weight. When this happens, the falling loose coins are received in the coin receiving unit 48. With this arrangement, when the packaging paper of the roll of coins is torn and the coins fall down by their weight when the roll of coins is transported by the endless belt 42, scattering of such coins inside the housing 2 can be prevented.

In the present embodiment, as shown in FIG. 3, a characteristic-value detecting unit 50 is arranged in the housing 2. The characteristic-value detecting unit 50 detects a first characteristic value relating to a diameter and a second characteristic value relating to material of the roll of coins transported by the transporting unit 40. The characteristic-value detecting unit 50 is arranged downstream of the topmost storing unit 10 with respect to a transportation direction of the roll of coins transported by the transporting unit 40. The characteristic-value detecting unit 50 detects the first characteristic value relating to the diameter and the second characteristic value relating to the material of the roll of coins fed out from the storing units 10 by the ejecting mechanism 19. Detailed explanation about a configuration of the characteristic-value detecting unit 50 is given below with reference to FIGS. 3 and 4.

As shown in FIGS. 3 and 4, the characteristic-value detecting unit 50 includes a detecting leaver 52, a magnet 54a, and an angle sensor 55. The detecting leaver 52 is rotatable around a shaft 54 and is capable of contacting the roll of coins transported by the transporting unit 40. The magnet 54a is arranged on the shaft 54 and is capable of rotating integrally with the detecting leaver 52. The angle sensor 55 detects a rotation angle of the detecting leaver 52 at an instant at which the roll of coins transported by the transporting unit 40 contacts the detecting leaver 52. The angle sensor 55 detects the rotation angle of the detecting leaver 52 based on a change in the magnetic field occurring because of the rotation of the magnet 54a. The first characteristic value relating to the diameter of the roll of coins transported by the transporting unit 40 is calculated from the rotation angle of the detecting leaver 52.

As shown in FIGS. 3 and 4, the characteristic-value detecting unit 50 includes at least a circuit 58a and a sensor 58b. The circuit 58a includes a coil and a capacitor. The sensor 58b detects an impedance characteristic and an inductance characteristic of the circuit 58a. An alternating current is applied to the coil of the circuit 58a whereby a predetermined magnetic field is generated near the circuit 58a. When the roll of coins transported by the transporting unit 40 passes the characteristic-value detecting unit 50, changes in the impedance characteristic and the inductance characteristic of the circuit 58a resulting from a shift of the roll of coins by a predetermined distance set previously is detected by the sensor 58b. The second characteristic value relating to the material of the roll of coins transported by the transporting unit 40 is calculated from an amount of change in the impedance characteristic and the inductance characteristic of the circuit 58a.

The first characteristic value relating to the diameter of the roll of coins and the second characteristic value relating to the material of the roll of coins detected by the characteristic-value detecting unit 50 are sent to the later-explained controlling unit 90. The controlling unit 90 includes a later-explained denomination determining section 92. The denomination determining section 92 determines a denomination of the roll of coins based on the first characteristic value relating to the diameter of the roll of coins and the second characteristic value relating to the material of the roll of coins.

As shown in FIGS. 3 and 4, in the characteristic-value detecting unit 50, a sensor 59, including a photo-interrupter and the like, is arranged upstream of both the detecting leaver 52 and the circuit 58a in the transportation direction of the roll of coins. The roll of coins transported by the transporting unit 40 is detected by the sensor 59 before the roll of coins reaches the detecting leaver 52 and the circuit 58a. By detecting the roll of coins with the sensor 59 arranged upstream of the detecting leaver 52 and the circuit 58a in the transportation direction of the roll of coins, a timing of the start of the detection in the characteristic-value detecting unit 50 of the first characteristic value relating to the diameter and the second characteristic value relating to the material of the roll of coins can be decided.

The reject unit 60 is arranged further downstream of the characteristic-value detecting unit 50 in the transportation direction of the roll of coins transported by the transporting unit 40. The roll of coins that is determined by the denomination determining section 92 to be of a denomination that should not be ejected from inside to outside of the housing 2 is sent from the transporting unit 40 to the reject unit 60. More particularly, a diverting lever 62 is arranged rotatably around a shaft 64 near the reject unit 60, and the roll of coins transported by the transporting unit 40 (specifically, the roll of coins transported by the endless belt 42 in the state of being caught by the protruding member 44) is diverted by the diverting lever 62 so as to be sent from the transporting unit 40 to the reject unit 60. Specifically, the diverting lever 62 is rotatable around the shaft 64 between an advanced position and a retracted position. The advanced position is a position in the movement area of the roll of coins transported by the transporting unit 40. The retracted position is a position that is not in this movement area. When the diverting lever 62 is located in the advanced position, the roll of coins transported by the endless belt 42 in the state of being caught by the protruding member 44 contacts the diverting lever 62, comes off from the protruding member 44, and sent to the reject unit 60. On the other hand, when the diverting lever 62 is located in the retracted position, the roll of coins transported by the transporting unit 40 is not sent to the reject unit 60.

As shown in FIG. 3, the reject unit 60 includes a full-state detection sensor 66. The full-state detection sensor 66 detects whether the reject unit 60 is full with or almost full with the roll of coins. Specifically, the full-state detection sensor 66 includes a light emitting element and a light receiving element arranged with a space therebetween, and light emitted from the light emitting element is received by the light receiving element. When the reject unit 60 is full with or almost full with the roll of coins whereby an optical axis between the light emitting element and the light receiving element is blocked by those roll of coins, the full-state detection sensor 66 detects that the reject unit 60 is full with or almost full with the roll of coins.

As shown in FIG. 1, FIG. 3, and the like, the ejecting unit 70 is arranged in a front upper part of the coin-roll processing device 1 according to the present embodiment. The ejecting unit 70 ejects the roll of coins transported by the transporting unit 40 from inside to outside of the housing 2. Detailed explanation about a configuration of the ejecting unit 70 is given below.

As shown in FIG. 3, FIG. 6, and the like, the ejecting unit 70 includes an accommodating section 72 that accommodates the roll of coins transported by the transporting unit 40. The accommodating section 72, to allow accommodation of several roll of coins, is formed into a curved and downward convex shape in a cross-section. An opening 2a is provided in a front surface of the housing 2. The roll of coins is sent from the inside of the housing 2 to the accommodating section 72 of the ejecting unit 70 via the opening 2a. A diverting lever 78 is arranged in the housing 2 but near the ejecting unit 70. The roll of coins transported by the transporting unit 40 is diverted by the diverting lever 78 to be sent by the transporting unit 40 to the ejecting unit 70 via the opening 2a, and accommodated in the accommodating section 72 of the ejecting unit 70. More particularly, the diverting lever 78 is movable between an advanced position and a retracted position. The advanced position is a position in a movement area of the roll of coins transported by the transporting unit 40. The retracted position is a position that is not in this movement area. When the diverting lever 78 is located in the advanced position, the roll of coins transported by the transporting unit 40 is sent to the ejecting unit 70 by the diverting lever 78. On the other hand, when the diverting lever 78 is located in the retracted position, the roll of coins transported by the transporting unit 40 is not sent to the ejecting unit 70.

As shown in FIG. 3, FIG. 4, and the like, a shutter 76 (a dispensing passage shutter) is provided in a front surface of the housing 2 and near the opening 2a to open or close the opening 2a. The shutter 76 is movable in the vertical direction in FIGS. 3 and 4. When the opening 2a is in the opened state by operation of the shutter 76, the roll of coins is sent from the transporting unit 40 to the ejecting unit 70.

The ejecting unit 70 includes a shutter 74 (a shutter for removal of the roll of coins) rotatable around a shaft 74a. The shutter 74 is rotatable between a closed position and an open position around the shaft 74a. When the shutter 74 is located in the closed position (shown with a continuous line in FIGS. 3 and 6), it blocks a coin-roll removal opening 71a provided in a front part of the accommodating section 72. When the shutter 74 is located in the open position (shown with a two-dot chain line in FIGS. 3 and 6), the coin-roll removal opening 71a is open. A front end of the accommodating section 72 is located near the shaft 74a of the shutter 74. When the shutter 74 is located in the closed position, the shutter 74 extends upward from the shaft 74a. The shutter 74 is reclined away from a body of the ejecting unit 70 when the shutter 74 is rotated from the closed position to the open position. More particularly, the shutter 74 is automatically opened or closed by being rotated by a not-shown driving motor around the shaft 74a between the closed position and the open position. Instead of automatically opening or closing the shutter 74, it is possible to adopt a configuration in which the operator manually inclines the shutter 74 away from the ejecting unit 70 to move the shutter 74 from the closed position to the open position.

In the present embodiment, when the shutter 74 is located in the open position, shown with the two-dot chain line in FIGS. 3 and 6, an inner surface (allocated with a reference number 74b in FIG. 6) of the shutter 74 continues smoothly from a placement surface 72a on which the roll of coins is placed in the accommodating section 72. Specifically, when the shutter 74 is located in the open position, the inner surface 74b of the shutter 74 and the placement surface 72a of the accommodating section 72 located near the shutter 74 lie substantially in one plane. Moreover, when the shutter 74 is located in the open position, both the inner surface 74b of the shutter 74 and the placement surface 72a of the accommodating section 72 located near the shutter 74 are inclined with respect to a horizontal plane. Furthermore, when the shutter 74 is located in the open position, a gap between the inner surface 74b of the shutter 74 and the placement surface 72a of the accommodating section 72 is narrower than a diameter of the roll of coins.

In this manner, in the ejecting unit 70, when the shutter 74 is located in the open position, the inner surface 74b of the shutter 74 and the placement surface 72a on which the roll of coins is placed in the accommodating section 72 continue smoothly. Accordingly, when, after opening the shutter 74, grasping the roll of coins accumulated in the accommodating section 72 with the hand, and taking them out by pulling toward the operator, the grasped roll of coins can be moved smoothly from the placement surface 72a of the accommodating section 72 along the inner surface 74b of the shutter 74. As a result, it is easy to take out a bunch of the roll of coins accumulated in the accommodating section 72.

In the present embodiment, as shown in FIG. 7, the accommodating section 72 includes a sheet-shaped base material 72b and a low friction member 72c provided on a top surface of the base material 72b. The base material 72b includes an impact absorber such as an impact absorption sponge. The low friction member 72c has a lower friction coefficient than the base material 72b. The roll of coins is placed on the low friction member 72c. As the low friction member 72c, a film of a polycarbonate sheet and the like that has, for example, resistance to wear and resistance to shocks, is used. It is desirable that the film is colored with a color that makes the roll of coins accommodated in the accommodating section 72 easy to see. It is preferable that a surface of the film is previously subjected to a surface processing to form a wrinkled pattern thereon. Because of the low friction member 72c such as the film, it is possible to prevent damage of the base material 72b by the claws and the like of the operator when the operator takes out the roll of coins from the accommodating section 72. Because the friction coefficient of the low friction member 72c is relatively low, when grasping the roll of coins accumulated in the accommodating section 72 with the hand and taking them out by pulling toward the operator, a finger or a fingernail of the operator, or the grasped roll of coins itself, is not easily caught in the low friction member 72c, whereby it is easy to take out a bunch of the roll of coins accumulated in the accommodating section 72.

As shown in FIG. 3, the coin-roll processing device 1 according to the present embodiment includes the controlling unit 90. The ejecting mechanism 19 of each of the storing units 10, the driving motor 46 of the transporting unit 40, the characteristic-value detecting unit 50, the diverting lever 62, the diverting lever 78, the shutter 76, and the like are connected to the controlling unit 90. Detection results (specifically, the first characteristic value relating to the diameter of the roll of coins and the second characteristic value relating to the material) obtained in the characteristic-value detecting unit 50 are sent to the controlling unit 90. The controlling unit 90 controls the various components, such as the ejecting mechanism 19 of each of the storing units 10, the driving motor 46 of the transporting unit 40, the diverting lever 62, the diverting lever 78, and the shutter 76, by sending a command signal to the corresponding component. Moreover, the controlling unit 90 includes the denomination determining section 92 that determines the denomination of the roll of coins ejected from each of the storing units 10 by the ejecting mechanism 19. The denomination determining section 92 determines the denomination of the roll of coins based on the first characteristic value relating to the diameter and the second characteristic value relating to the material of the roll of coins, both detected by the characteristic-value detecting unit 50.

In the present embodiment, the coin-roll processing device 1 is a safe and only an authorized person (for example, a supervisor of the branch in which the coin-roll processing device 1 is installed) can access to the inside of the safe. Specifically, as shown in FIG. 1, a front lower part of the housing 2 is provided with a lower part door 4 having a keylock 6. Only the authorized person can open the lower part door 4 by unlocking the keylock 6 with a key possessed by him and access the inside of the housing 2. In this manner, in the coin-roll processing device 1 according to the present embodiment, the storing units 10, the transporting unit 40, and the characteristic-value detecting unit 50 are all arranged inside the safe, and an access to the inside of the safe is restricted to the authorized person.

An operation of the coin-roll processing device 1 having such a configuration is explained below. The operation of the coin-roll processing device 1 explained below is performed by the controlling unit 90 by controlling the various components of the coin-roll processing device 1.

A dispensing process of the roll of coins of ejecting the roll of coins outside of the housing 2 from inside of the coin-roll processing device 1 according to the present embodiment is explained below. In the coin-roll processing device 1, when an instruction to perform the dispensing process of the roll of coins is inputted into the controlling unit 90 via a not-shown operating unit, the roll of coins is fed out from the storing units 10 by the ejecting mechanism 19, and the fed-out roll of coins is transported one by one by the transporting unit 40. Specifically, the roll of coins fed out from the storing units 10 by the ejecting mechanism 19 is transported by the endless belt 42, in the state of being caught by the protruding member 44, in the direction shown with the straight arrow in FIG. 3. The first characteristic value relating to the diameter and the second characteristic value relating to the material of the roll of coins transported by the transporting unit 40 is detected by the characteristic-value detecting unit 50.

Both the first characteristic value relating to the diameter and the second characteristic value relating to the material of the roll of coins detected by the characteristic-value detecting unit 50 are sent to the controlling unit 90. The denomination of the roll of coins is determined by the denomination determining section 92 of the controlling unit 90 based on both the first characteristic value relating to the diameter and the second characteristic value relating to the material of the roll of coins.

The roll of coins that has passed the characteristic-value detecting unit 50 is transported further by the transporting unit 40. The roll of coins that is determined by the denomination determining section 92 to be of a denomination that should not be ejected from inside to outside of the housing 2 is diverted by the diverting lever 62 from the transporting unit 40 and sent to the reject unit 60. On the other hand, the roll of coins that is determined by the denomination determining section 92 to be of a denomination that should be ejected from inside to outside of the housing 2 is diverted by the diverting lever 78 from the transporting unit 40 and sent to the accommodating section 72 of the ejecting unit 70 via the opening 2a. When all the roll of coins of a predetermined number of a desired denomination are fed out from the storing units 10 and sent to the ejecting unit 70, the shutter 74 of the ejecting unit 70 automatically opens by reclining toward the front side of a front surface 71 of the ejecting unit 70. Accordingly, the operator can take out the roll of coins from the accommodating section 72 to the outside of the ejecting unit 70. In this case, in the present embodiment, in the ejecting unit 70, the placement surface 72a on which the roll of coins is placed in the accommodating section 72 and the inner surface 74b of the shutter 74 that is open toward the operator continue smoothly. Accordingly, after opening the shutter 74, it is easy to take out a bunch of the roll of coins accumulated in the accommodating section 72 while grasping with a hand and pulling them out toward the operator. Because the friction coefficient of the low friction member 72c on which the roll of coins is placed in the accommodating section 72 is relatively low, when grasping the roll of coins accumulated in the accommodating section 72 with the hand and taking them out by pulling toward the operator, a finger or a fingernail of the operator, or the grasped roll of coins itself, is not easily caught in the low friction member 72c, whereby it is easy to take out a bunch of the roll of coins accumulated in the accommodating section 72.

What is claimed is:

1. An ejecting unit for ejecting a roll of coins from inside to outside of a housing of a coin-roll processing device, comprising:
an accommodating section that accommodates a roll of coins to be ejected from inside to outside of the housing; and
a shutter rotatable between a closed position and an open position around a shaft, the closed position being a position in which the shutter blocks a coin-roll removal opening provided in a front part of the accommodating section and the open position being a position in which the coin-roll removal opening is open, wherein
when the shutter is located in the open position, a placement surface on which the roll of coins is placed in the accommodating section and an inner surface of the shutter continue smoothly.

2. The ejecting unit as claimed in claim 1, wherein, the shutter extends upward from the shaft when the shutter is located in the closed position, and the shutter is reclined away from a body of the ejecting unit when the shutter is rotated from the closed position to the open position.

3. The ejecting unit as claimed in claim 1, wherein a front end of the accommodating section is located near the shaft of the shutter.

4. The ejecting unit as claimed in claim 1, wherein, when the shutter is located in the open position, the inner surface of the shutter and the placement surface of the accommodating section located near the shutter are substantially in one plane.

5. The ejecting unit as claimed in claim 4, wherein, when the shutter is located in the open position, both the inner surface of the shutter and the placement surface of the accommodating section located near the shutter are inclined to a horizontal plane.

6. The ejecting unit as claimed in claim 1, wherein a gap between the inner surface of the shutter when the shutter is located in the open position and the placement surface of the accommodating section is narrower than a diameter of the roll of coins.

7. The ejecting unit as claimed in claim 1, wherein the accommodating section includes a base material and a low friction member that is provided on a top surface of the base material and has a lower friction coefficient than the base material, and the roll of coins accommodated in the accommodating section is placed on the low friction member.

8. The ejecting unit as claimed in claim 7, wherein the base material includes an impact absorber.

9. The ejecting unit as claimed in claim 7, wherein the low friction member includes a film.

10. A coin-roll processing device comprising:
a storing unit that stores a roll of coins and capable of feeding out the stored roll of coins;
a transporting unit that transports the roll of coins fed out from the storing unit; and
the ejecting unit as claimed in claim 1, wherein
the roll of coins transported by the transporting unit to the ejecting unit is accommodated in the accommodating section of the ejecting unit.

11. An ejecting unit for ejecting a roll of coins from inside to outside of a housing of a coin-roll processing device, comprising:
an accommodating section that accommodates a roll of coins to be ejected from inside to outside of the housing; and
a shutter rotatable between a closed position and an open position around a shaft, the closed position being a position in which the shutter blocks a coin-roll removal opening provided in a front part of the accommodating section and the open position being a position in which the coin-roll removal opening is open, wherein
the accommodating section includes a base material and a low friction member that is provided on a top surface of the base material and has a lower friction coefficient than the base material, and the roll of coins accommodated in the accommodating section is placed on the low friction member.

12. The ejecting unit as claimed in claim 11, wherein the base material includes an impact absorber.

13. The ejecting unit as claimed in claim 11, wherein the low friction member includes a film.
